(19) United States
(12) Patent Application Publication
(10) Pub. No.: US 2025/0353380 A1
(43) Pub. Date: Nov. 20, 2025

(54) RANGE EXTENSION WITH OPTIMAL TRACTION CONTROL FOR MULTI E-AXLE BASED ELECTRIFIED VEHICLES

(71) Applicant: Ohio State Innovation Foundation, Columbus, OH (US)

(72) Inventors: Ahmad Hussain Safder, Columbus, OH (US); Athar Hanif, Columbus, OH (US); Qadeer Ahmed, Columbus, OH (US)

(21) Appl. No.: 19/207,877

(22) Filed: May 14, 2025

Related U.S. Application Data
(60) Provisional application No. 63/647,772, filed on May 15, 2024.

(51) Int. Cl. B60L 15/20; B60L 7/10; B60L 50/60; B60L 58/12

(52) U.S. Cl. CPC B60L 15/2045; B60L 7/10; B60L 50/60; B60L 58/12; B60L 2200/36; B60L 2240/12; B60L 2240/423; B60L 2240/642

(57) ABSTRACT

Systems and methods for range extension with optimal traction control for multi e-axle based electrified vehicles are disclosed. The systems and methods optimize the operation of electric vehicles with multiple e-axles by generating optimal torque profiles based on look-ahead information about road conditions and optimally distributing torque between e-axles to minimize energy losses and extend driving range. The optimal traction control system operates in three main steps: first, generating an optimal torque profile based on look-ahead information about road grade and speed limits; and second, optimally allocating the requested torque between multiple e-axles to minimize energy losses. Third, dynamic drive control for electric machine to track optimal torque with minimized current. The optimal torque profile follows the trend of the road grade, providing more torque on uphill sections and less torque or even negative torque on downhill sections.

### CROSS REFERENCE TO RELATED APPLICATION

This application claims priority to U.S. Provisional Patent Application No. 63/647,772, filed May 15, 2024, entitled “Look Ahead Information Based Energy Efficient Dynamic Drive Control for Multi EM or Axle-Based Electrified,” which is incorporated herein by reference in its entirety.

### BACKGROUND

Range anxiety, the fear that an electric vehicle (EV) may run out of battery before reaching its destination or a charging station, remains a significant hurdle to EV adoption. While advances in battery technology and the expansion of charging infrastructure have eased this concern for passenger EVs, it remains a critical issue, especially for heavy-duty electric trucks. These trucks are rapidly gaining popularity as industries look to reduce emissions and transition toward sustainable transportation solutions. However, their operational demands and unique challenges make range anxiety a more pressing concern.

For example, heavy-duty electric trucks consume significantly more energy than passenger vehicles due to their size, weight, and the need to carry substantial loads over long distances. This high energy demand requires large, powerful batteries, which increase vehicle weight and exacerbate efficiency concerns. Additionally, these trucks often operate on long-haul routes through remote areas where charging infrastructure is sparse. The necessity to maintain tight delivery schedules and the longer charging times further intensify range anxiety. Despite their growing appeal in reducing carbon footprint and meeting regulatory constraints, the uncertainty of range reliability presents a significant barrier to widespread adoption in industries that rely on consistent performance and uptime. This makes it crucial for these vehicles to operate efficiently, maximizing their range and minimizing energy consumption.

### SUMMARY

Systems and methods for range extension with optimal traction control for multi e-axle based electrified vehicles are disclosed. In one aspect, a method for optimizing traction control in an electric vehicle with multiple e-axles includes receiving look-ahead information about upcoming road conditions, generating an optimal torque profile based on the look-ahead information, and optimally allocating the requested torque between multiple e-axles to minimize energy losses.

In another aspect, a system for optimizing traction control in an electric vehicle with multiple e-axles includes a vehicle control unit configured to receive look-ahead information and generate an optimal torque profile, an e-axles supervisory controller configured to optimally allocate torque between multiple e-axles, and electric machine controllers configured to implement the allocated torque commands.

In yet another aspect, a method for extending the range of an electric vehicle includes optimizing a torque profile based on look-ahead information about road grade and speed limits, determining an optimal torque split between multiple e-axles to minimize energy losses, and controlling the electric machines according to the optimal torque split.

The systems and methods disclosed herein provide significant improvements in energy efficiency and driving range for electric vehicles with multiple e-axles, particularly heavy-duty electric trucks. By optimizing both the torque profile and the torque distribution between e-axles, the disclosed approaches can reduce energy consumption, minimize powertrain losses, and extend driving range compared to conventional control strategies.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The foregoing summary, as well as the following detailed description of illustrative implementations, is better understood when read in conjunction with the appended drawings. To illustrate the implementations, there are shown in the drawings example constructions; however, the implementations are not limited to the specific methods and instrumentalities disclosed. In the drawings:

FIG. 1 is a schematic diagram illustrating the powertrain architecture of an electric truck with dual e-axles according to an example implementation.

FIG. 2 illustrates and example operational flow of an optimal traction control system.

FIG. 3 is a block diagram illustrating an optimal traction control system according to an example implementation.

FIG. 4 is a graph illustrating an efficiency map of an electric machine according to an example implementation.

FIG. 5 is a graph illustrating an optimal torque profile generated by the optimal traction control system according to an example implementation.

FIG. 6 is a graph illustrating an optimal torque split generated by the optimal traction control system according to an example implementation.

FIG. 7 is a graph illustrating the frequency of each optimal torque split according to an example implementation.

FIGS. 8A and 8B illustrate a comparison of electric machine operating points between optimal torque with optimal split (OTOS) and conventional control (CC) strategies according to an example implementation.

FIGS. 9A and 9B illustrate a comparison of electric machine operating points between optimal torque with optimal split (OTOS) and optimal torque with even split (OTES) strategies according to an example implementation.

FIG. 10 is a graph illustrating vehicle speed profiles with different control strategies according to an example implementation.

FIGS. 11A and 11B illustrate battery energy profiles with different control strategies according to an example implementation.

FIG. 12 is a graph illustrating the impact of road grade variation on vehicle speed according to an example implementation.

FIG. 13 illustrates another electric machine control system according to an example implementation.

FIGS. 14A-14B illustrate a neural network architecture for torque estimation, testing and validation according to an example implementation

FIG. 15 is an example block diagram of PINN based PMSM Parameter Estimator.

FIG. 16 illustrates an overview of a PMSM control method in accordance with the above.

FIG. 17 is an overview showing the relationships between the aspects described herein to provide an Energy Optimal Traction Control system.

### DETAILED DESCRIPTION

Described herein are systems and methods for range extension with optimal traction control for multi e-axle based electrified vehicles. The systems and methods optimize the operation of electric vehicles with multiple e-axles by generating optimal torque profiles based on look-ahead information about road conditions and optimally distributing torque between e-axles to minimize energy losses and extend driving range.

The present disclosure addresses the challenge of range anxiety in electric vehicles, particularly heavy-duty electric trucks, by optimizing powertrain operations for efficiency. The disclosed approach includes a three-step control strategy: first, generating an optimal torque profile based on look-ahead information about road conditions; and second, optimally allocating the requested torque between multiple e-axles to minimize energy losses. Third, dynamic drive control for electric machine to track the optimal torque with minimized current.

The following acronyms and symbols shown in TABLE I are used throughout the specification:
EM—Traction Electric Machine
SQP—Sequential Quadratic Programming
CC—Conventional Control (speed tracking with even split)
OTOS—Optimal Torque Optimal Split (Proposed control)
OTES—Optimal Torque Even Split
SOC—State of Charge
SOC₀—Initial State of Charge
SOCₘᵢₙ—Minimum State of Charge
SOCₘₐₓ—Maximum State of Charge
τ_{req}—Total requested torque by both EM
ω_{req}—Requested EM speed
τ_{EM}Ax1—Torque provided by EM at e-axle
τ_{EM}Ax2—Torque provided by EM at e-axle 2
η_{EM}Ax1—EM efficiency at e-axle 1
η_{EM}Ax2—EM efficiency at e-axle 2
Ω_{EM}—Torque Split Ratio between both EM
ω_{EM}—EM speed
η_{g}(Ax1,Ax2)—gearbox efficiency at e-axle 1 and 2
λg—Gear ratio of gearbox at both e-axles
ωg—Gearbox output speed
τg(Ax1,Ax2)—Torque provided by gearbox at axle 1 and 2
η_{d}(Ax1,Ax2)—Differential gear efficiency at e-axle 1 and 2
λ_{d}—Gear ratio of differential gear at both e-axles
ω_{d}—Differential gear output speed
τ_{d}(Ax1,Ax2)—Torque provided by differential gear at axle 1 and 2
P_{batt}req—Power requested from battery
I_{cell}—Current drawn from each battery cell
V_{batt}—Battery terminal voltage
Q_{cell}—Energy capacity of each cell
Fr—Rolling resistance force
F_{d}—Air drag force
Fg—Road grade force
crr—Rolling resistance coefficient
Mᵥₑₕ—Vehicle mass
g—Gravitational acceleration
α—Road grade
A_{f}—Vehicle frontal area
ρ—Air density
F_{load}—Total resistive load
P_{load}—Total required power at the wheels
J₁—Cost function for optimal torque profile
vᵥₑₕ—Vehicle speed
v_{ref}—Reference speed
w₁—Penalty factor for energy consumption
w₂—Penalty factor for speed error
w₃—Penalty factor for SOC exceeding limits
d_{safe}—Safe distance from lead vehicle
dᵣₑₗₐₜᵢᵥₑ—Relative distance from lead vehicle
vₗᵢₘ—Speed limit
vₘᵢₙ—Minimum speed
αᵥₑₕ—Vehicle acceleration
αₘₐₓ—Maximum vehicle acceleration
αₘᵢₙ—Minimum vehicle acceleration
r_{wheel}—Vehicle wheel radius
ηₜₒₜₐₗ—Total powertrain efficiency
Ω_{EM}—Optimal torque split ratio
d—Look-ahead distance
dx—Distance segment for prediction
N—Number of segments in look-ahead distance
π—Lagrange multiplier for inequality constraints
μ—Lagrange multiplier for equality constraint
Δα—Variation in road grade
Param.—Performance parameter
Δparam—Variation in performance parameter

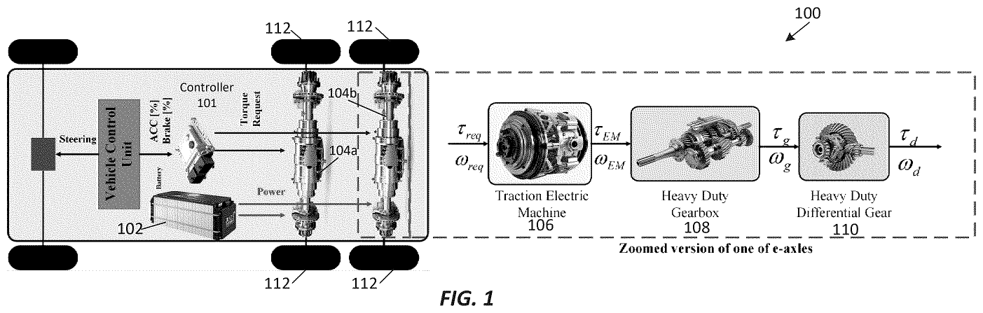

Referring to FIG. 1, a schematic diagram illustrates the powertrain architecture 100 of an electric truck with dual e-axles according to an example implementation. The powertrain 100 includes a controller 101, a battery system 102 that provides electrical energy to two e-axles 104a, 104b. Each e-axle comprises an electric machine (EM) 106, a gearbox 108, and a differential gear 110. The electric machines convert electrical energy from the battery 102 into mechanical torque to drive the wheels 112. The gearbox provides appropriate gear ratios for efficient operation, and the differential gear distributes torque to the wheels while allowing them to rotate at different speeds during turns.

The simplified powertrain architecture (e.g., architecture 100) of electric trucks improves both reliability and energy efficiency by reducing mechanical complexity compared to conventional diesel trucks. However, efficiently managing power distribution between the two e-axles, especially under varying operating conditions, remains a challenge. Conventional traction controllers typically distribute power evenly between the e-axles, which may not be optimal for energy efficiency. Below is described an improved system and method to achieve optimal energy efficiency.

### Electric Machine Modeling

The equations that define the torques and speed of the EMs are shown in Eq. (1), Eq. (2) and Eq. (3), where Ω_{EM}∈[0, 1] is the torque split. All other symbols are explained in Table I.

$${τ}_{{EM}_{Ax 1}} = {Ω}_{EM} \cdot {η}_{{EM}_{Ax 1}} \times {τ}_{req} \qquad ( 1 )$$

$${τ}_{{EM}_{Ax 2}} = ( 1 - {Ω}_{EM} ) \times {η}_{{EM}_{Ax 2}} \times {τ}_{req} \qquad ( 2 )$$

$${ω}_{{EM}_{Ax 1}} = {ω}_{{EM}_{Ax 2}} = {ω}_{req} = {ω}_{EM} \qquad ( 3 )$$

### Gearbox Modeling

The considered e-axle has a gearbox with two gears with certain mechanical efficiency. It is assumed that the gear number will be the same on each e-axle at every operating condition. Using the gear ratio λ_{g}≥1, the following torque and speeds can be calculated at the gearbox output:

$${λ}_{{g}_{( Ax 1 , Ax 2 )}} = {λ}_{g} \qquad ( 4 )$$

$${τ}_{g ( Ax 1 , Ax 2 )} = {λ}_{g} \times {η}_{g ( Ax 1 , Ax 2 )} \times {τ}_{{EM}_{( Ax 1 , Ax 2 )}} \qquad ( 5 )$$

$${ω}_{g ( Ax 1 , Ax 2 )} = {ω}_{g} = \frac{{ω}_{EM}}{{λ}_{g}} \qquad ( 6 )$$

### Differential Modeling

The differential propagates the power coming from the gearbox to both wheels through a final gear ratio λ_{d}. The resulting torque and speed can be calculated as follows:

$${λ}_{{d}_{( Ax 1 , Ax 2 )}} = {λ}_{d} \qquad ( 7 )$$

$${τ}_{{d}_{( Ax 1 , Ax 2 )}} = {λ}_{d} \times {η}_{{d}_{( Ax 1 , Ax 2 )}} \times {τ}_{{g}_{( Ax 1 , Ax 2 )}} \qquad ( 8 )$$

$${ω}_{{d}_{( Ax 1 , Ax 2 )}} = {ω}_{d} = \frac{{ω}_{g}}{{λ}_{d}} \qquad ( 9 )$$

### Battery Modeling

The semi empirical 0-th order equivalent circuit model is used for battery modeling, shown in Eq. (10)-Eq. (12)

$${P}_{{batt}_{req}} = {τ}_{req} \times {ω}_{req} \qquad ( 10 )$$

$${I}_{cell} = \frac{{P}_{{batt}_{req}}}{{n}_{p} \times {V}_{batt}} \qquad ( 11 )$$

$$SOC = {SOC}_{0} - {\sum }_{i = 1}^{n} \frac{{I}_{{cell}_{s}}}{{Q}_{{cell}_{s}}} \qquad ( 12 )$$

### Optimal Traction Control Design

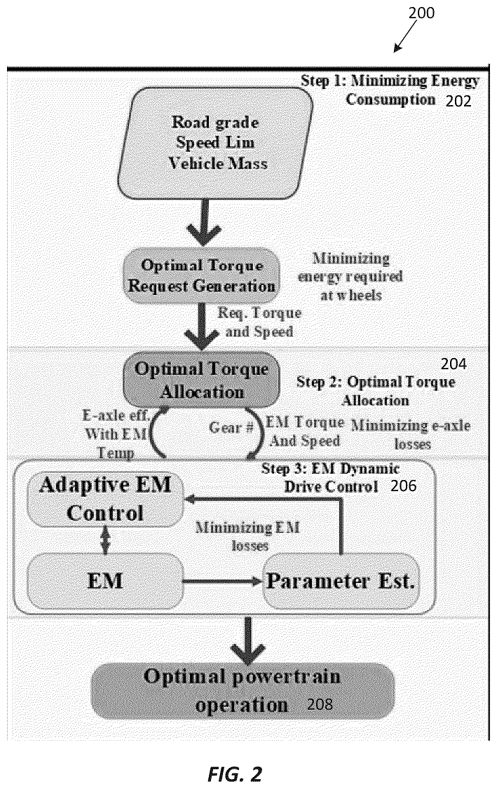

FIG. 2 illustrates and example operational flow 200 of an optimal traction control system in accordance with aspects of the present disclosure. At 202 (Minimizing Energy Consumption), energy consumption is optimized at vehicle level by calculating optimal acceleration with the information of speed limits, road grade, and vehicle mass. Then this optimal acceleration is translated into optimal torque request at the wheels. FIG. 2 shows this optimal torque request is the input of optimal torque allocation algorithm.

At 204 (Optimal Torque Allocation), optimal torque allocation at powertrain level is determined. This minimizes energy losses within the e-axles, ensuring that both EMs operate as efficiently as possible. This optimal power split is based on a detailed understanding of the energy losses in both e-axles, taking into account factors like EM efficiency, transmission losses, and operational load conditions. However, this optimization introduces a challenge. The optimal power split often results in uneven thermal stress on the EMs which leads to varying operating temperatures and causes nonuniform variations in the electrical parameters of the EMs. As the thermal stress deviates across the EMs, it can degrade EM performance and makes conventional EM control strategies less effective. As a result, while this step ensures minimal energy loss on the e-axles, it also introduces a challenge that requires additional control strategies to maintain EM performance.

At 206 (EM Dynamic Drive Control), this is at the EM level, and addresses the challenge introduced in 204 by developing a dynamic drive control system that helps mitigate the effects of uneven thermal stress on the EMs. This control strategy employs virtual sensors to estimate the EM parameters and determine the temperature profile of both EMs in the real-time.

At 208, the dynamic drive control then uses this information to adjust the operational conditions and optimize the EM performance.

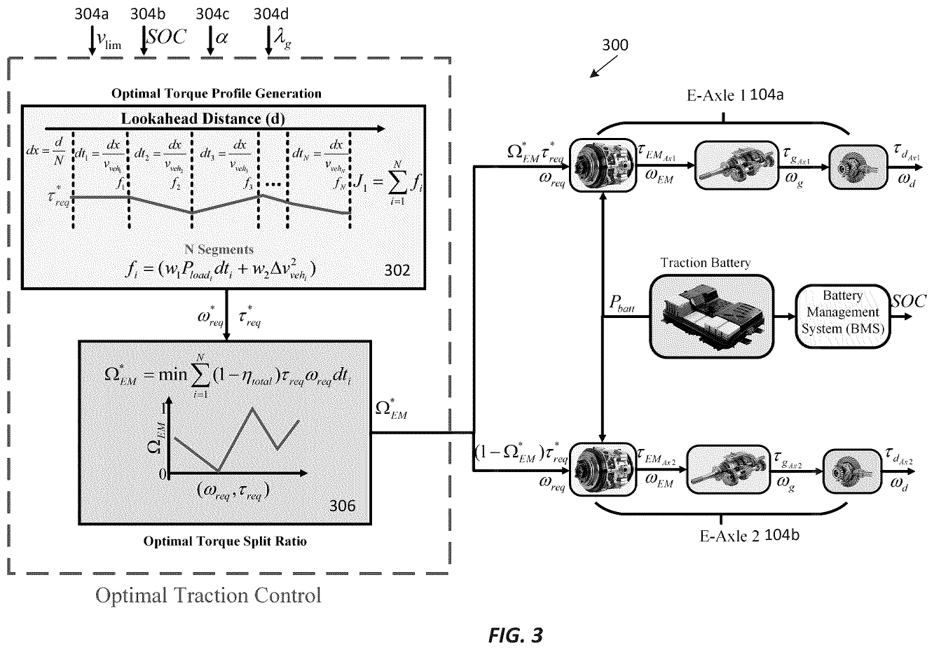

Referring to FIG. 3, a block diagram illustrates an optimal traction control system 200 according to an example implementation. The system includes a vehicle control unit 202 that receives look-ahead information 304a-304d about road conditions, an e-axles supervisory controller 306 that optimally allocates torque between e-axles 104a, 104b, and electric machine controllers that implement the allocated torque commands.

The optimal traction control system 300 operates in two main steps. In the first step, the vehicle control unit generates an optimal torque profile based on look-ahead information about road grade and speed limits. In the second step, the e-axles supervisory controller optimally allocates the requested torque between the two e-axles to minimize energy losses, as described below.

The look-ahead information 304a-304d includes data about upcoming road conditions, such as road grade and speed limits. This information helps the controller predict the vehicle's energy requirements and optimize the torque profile accordingly. The optimal torque profile minimizes energy consumption while maintaining acceptable vehicle performance.

The optimal torque allocation considers the efficiency of each e-axle 104a, 104b at different operating points and distributes torque to minimize overall energy losses. This may result in uneven torque distribution between the e-axles, with one e-axle sometimes providing all the required torque while the other remains inactive.

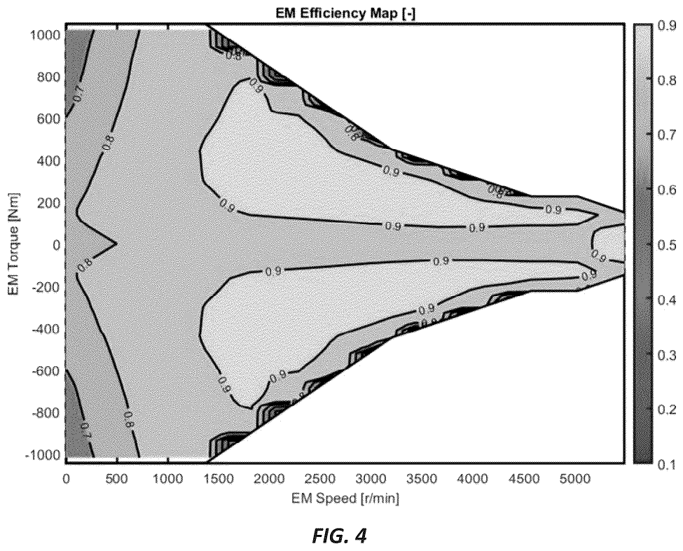

Referring to FIG. 4, there is illustrated a graph of an efficiency map of an electric machine according to an example implementation. The efficiency map shows the efficiency of the electric machine at different operating points defined by speed and torque. The efficiency varies significantly across the operating range, with peak efficiency typically occurring at moderate torque and speed values.

The efficiency map is used by the optimal torque allocation algorithm to determine the most efficient operating points for each electric machine. By considering these efficiency maps, the algorithm can distribute torque between the e-axles to maximize overall powertrain efficiency.

### Optimal Torque Profile Generation

The optimal torque profile for the electric machines is generated by integrating look-ahead information with the supervisory control of both axles. The look-ahead information about speed limits (vₗᵢₘ) and road grade (α) helps the controller calculate the vehicle load, which includes rolling resistance force (Fᵣ), air drag force (F_{d}), and road grade force (F_{g}). The mathematical formulation of these forces is as follows:

$${F}_{r} = {c}_{rr} \times {M}_{veh} \times g \times cos ( α ) \qquad ( 13 )$$

$${F}_{d} = 0.5 \times {c}_{d} \times {A}_{f} \times ρ \times {v}_{veh}^{2} \qquad ( 14 )$$

$${F}_{g} = {M}_{veh} \times g \times sin ( α ) \qquad ( 15 )$$

$${F}_{load} = {F}_{r} + {F}_{d} + {F}_{g} \qquad ( 16 )$$

The power (P_{load}) required at the wheels to overcome the vehicle load is calculated as follows:

$${P}_{load} = {F}_{load} \times {v}_{veh} \qquad ( 17 )$$

The cost function to generate the optimal torque profile is formulated as follows:

$${J}_{1} = {\sum }_{i = 1}^{N} {w}_{1} {P}_{{load}_{i}} {dt}_{i} + {{w}_{2} ( {v}_{{ref}_{i}} - {v}_{{veh}_{i}} )}^{2} \\ \{ \begin{matrix}{a}_{m i n} ( {M}_{veh} ) \leq {a}_{veh} \leq {a}_{m ax} ( {M}_{veh} ) \\ {v}_{m i n} \leq {v}_{veh} \leq {v}_{li m} \\ {d}_{safe} \leq {d}_{relative}\end{matrix} \qquad ( 18 )$$

Where v_{ref}=vₗᵢₘ·aₘₐₓ(Mᵥₑₕ) and aₘᵢₙ(Mᵥₑₕ) are shown in Eq. (19) and Eq. (20), respectively. The acceleration limits are a function of vehicle mass because at different loading conditions trucks acceleration and deceleration limits can be significantly different.

$${a}_{ma x} ( {M}_{veh} ) = \frac{{λ}_{g} {λ}_{d} ( {τ}_{{EM}_{m {ax}_{Ax 1}}} + {τ}_{{EM}_{m {ax}_{Ax 2}}} ) - {F}_{load}}{1.1 {M}_{veh} {r}_{wheel}} \qquad ( 19 )$$

$${a}_{m i n} ( {M}_{veh} ) = \frac{{λ}_{g} {λ}_{d} ( {τ}_{{EM}_{m i {n}_{Ax 1}}} + {τ}_{{EM}_{m i {n}_{Ax 2}}} ) - {F}_{load}}{1.1 {M}_{veh} {r}_{wheel}} \qquad ( 20 )$$

The optimal torque profile (τ_{reg}*) is calculated by minimizing the cost function:

$${τ}_{req}^{*} = {arg min}_{{a}_{veh}} {J}_{1} \qquad ( 21 )$$

The steps for optimal torque profile are presented in Algorithm 1, below. Firstly, the function (ƒ(αᵥₑₕ)) is evaluated in each segment of the look-ahead distance. Further, the Lagrangian function (L(αᵥₑₕ, π, μ)) is formulated with equality (h(αᵥₑₕ)) and inequality (g(αᵥₑₕ) constraints. The computed Lagrangian function is used to find the hessian (∇L(αᵥₑₕ, π, μ)), which provides the information of the curvature of the cost function that leads to a minimum value of the cost function. ∇L(αᵥₑₕ, π, μ) helps to formulate the sub-quadratic problem to find the optimal direction (y*) for the optimal solution. y* tells either the vehicle needs to accelerate or decelerate. Once the optimal direction is evaluated, the algorithm computes the optimal step size (y*) which tells how much acceleration or deceleration is needed. Consequently, the value of veh is calculated. This value further tested with the first order optimality condition: if the condition is satisfied, then the computed value of αᵥₑₕ is accepted as the optimal acceleration value αᵥₑₕ*. Lastly, the optimal torque (τ_{req}*). is computed.

Algorithm 1 is described below:

Algorithm 1 SQP routine for optimal torque profile

```
Require: Look-ahead Information( [symbol] )
Require: Vehicle Information (M [symbol] )
Limit: aₘᵢₙ ≤ aᵥₑₕ ≤ a [symbol]
Procedure:
Step 1 to step 7 explain the working of SQP
Step 1:
Evaluate the function:
$\text{?}$
$\text{?}$
Step 2:
Check Primary Feasiblility with inequality (g(aᵥₑₕ) ≤ 0)
and equality, ( [symbol] ( [symbol] ) = 0) constraints
  $\text{?}$
Step 3:
compute lagrangian:
$\text{?}$
Step 4:
Calculate the direction of optimal solution (y)
  ${y}^{*} = {min}_{y} ∇ {f ( a \text{?} )}^{T} y + \frac{1}{2} {y}^{T} ∇ ℒ ( a \text{?} , π , μ ) y$
    $\{ \begin{matrix}∇ {h ( a \text{?} )}^{T} y + h ( a \text{?} ) = 0 \\ ∇ {g ( a \text{?} )}^{T} y + g ( a \text{?} ) \leq 0\end{matrix}$
Step 5:
Calculate optimal step size (γ)
      ${γ}^{*} = {min}_{γ} ( a \text{?} + γ {y}^{*} )$
Step 6:
Calculate next acceleration value
      a [symbol]  = a [symbol]  + y* γ*
Step 7:
Check first order optimal condition
if ∇ [symbol] [symbol]   (a [symbol] , π, μ) = 0 then a [symbol]  = a* [symbol]
if ∇ [symbol] [symbol]   (a [symbol] , π, μ) ≠ 0 then go to Step 1.
Step 8:
Calculate Optimal Torque Profile
  ${τ}_{req}^{*} = \frac{( 1.1 M \text{?} a \text{?} + {F}_{load} ( a \text{?} ) ) {r}_{wheel}}{{λ}_{g} {λ}_{d}}$ [symbol]
indicates data missing or illegible when filed
```

### Optimal Torque Split

The optimal torque allocation aims to minimize the energy losses of the overall powertrain. The objective function considers the power losses at EM (P_{lossEM}), gear box (P_{lossg}), and differential gear (P_{lossdiff}) and splits the torque such that the overall efficiency of both e-axles is maximized.

$${p}_{req} = {ω}_{req} {τ}_{req} \qquad ( 22 )$$

$${p}_{{loss}_{EM}} = {Ω}_{EM} ( 1 - {η}_{{EM}_{1}} ) {ω}_{req} {τ}_{req} + ( 1 - {Ω}_{EM} ) ( 1 - {η}_{{EM}_{2}} ) {ω}_{req} {τ}_{req} \qquad ( 23 )$$

$${p}_{{loss}_{g}} = ( 1 - {η}_{{g}_{Ax 1}} ) {ω}_{EM} {τ}_{{EM}_{Ax 1}} + ( 1 - {η}_{{g}_{Ax 2}} ) {ω}_{EM} {τ}_{{EM}_{Ax 2}} \qquad ( 24 )$$

$${p}_{{loss}_{d}} = ( 1 - {η}_{{d}_{Ax 1}} ) {ω}_{g} {τ}_{{g}_{Ax 1}} + ( 1 - {η}_{{d}_{Ax 2}} ) {ω}_{g} {τ}_{{g}_{Ax 2}} \qquad ( 25 )$$

$${η}_{total} = \frac{{p}_{req} - {p}_{{loss}_{EM}} - {p}_{{loss}_{g}} - {p}_{{loss}_{d}}}{{p}_{req}} \qquad ( 26 )$$

$${J}_{2} = {\sum }_{i = 1}^{N} ( 1 - {η}_{{total}_{i}} ) {p}_{{req}_{i}} {dt}_{i} \\ \{ \begin{matrix}0 \leq {Ω}_{EM} \leq 1 \\ {λ}_{{g}_{Ax 1}} = {λ}_{{g}_{Ax 2}} \\ {SOC}_{m i n} \leq SOC \leq {SOC}_{m ax}\end{matrix} \qquad ( 27 )$$

$${Ω}_{EM}^{*} = {arg min}_{1 - {η}_{totoal}} {J}_{2} \qquad ( 28 )$$

The process to evaluate the optimal torque split is described by Algorithm 2, below. Firstly, the SQP algorithm evaluates the cost function f(Ω_{EM}). Secondly, it formulates the Lagrangian (L( [symbol] , π, μ)) incorporating all equality (h(Ω_{EM})) and inequality (g(Ω_{EM})) constraints. Where π and μ are the Lagrange multipliers for inequality and equality constraints, respectively. By validating g( [symbol] )≤0 and h( [symbol] )=0, the algorithm ensures the primary feasibility. In the third step, the SQP algorithm calculates the next guess by converting the cost function into a quadratic sub-problem. After calculating the optimality direction (y*) and step size (y*), the next guess for the torque split is calculated. Lastly, if the calculated value of Ω_{EM} satisfies the first order optimality condition, then it is accepted as the optimal torque split, Ω_{EM}*

Algorithm 2 is described below:

Algorithm 2 SQP routine for optimal torque split Ratio

```
Require: Requested Operating Point ω_{req} and [symbol] _{req}
Limit: τ_{EM}_{ₘᵢₙ} ≤ [τ_{EM} [symbol] , τ_{EM} [symbol] ] ≤ τ_{EM}_{ₘₐₓ}
Procedure:
Step 1 to step 7 explain the working of SQP
Step 1:
Evaluate the function: ƒ(Ω_{EM}) = J₂
Step 2:
Check Primary Feasibility: g(Ω_{EM}) ≤ 0, h(Ω_{EM}) = 0
  $g ( {Ω}_{{EM}_{1}} ) = \{ \begin{matrix}0 - {Ω}_{EM} < 0 \\ {Ω}_{{EM}_{1}} - 1 < 0 \\ {SOC}_{min} - SOC < 0 \\ SOC - {SOC}_{max} < 0\end{matrix}$
    h(Ω_{EM}_{₁}) = {λ [symbol]  − λ [symbol]  = 0
Step 3:
Compute lagrangian:
$ℒ ( {Ω}_{EM} , π , μ ) = f ( {Ω}_{EM} ) + {\sum }_{i = 1}^{N} {π}_{i} {g}_{i} ( {Ω}_{EM} ) + {\sum }_{i = 1}^{N} {μ}_{i} {h}_{i} ( {Ω}_{EM} )$
Step 4:
Compute optimal solution direction, step size and value
    ${y}^{*} = {min}_{y} ∇ {f ( {Ω}_{EM} )}^{T} y + {y}^{T} ∇ ℒ y$
    $\{ \begin{matrix}∇ {h ( {Ω}_{EM} )}^{T} y + h ( {Ω}_{EM} ) = 0 \\ ∇ {g ( {Ω}_{EM} )}^{T} y + g ( {Ω}_{EM} ) \leq 0\end{matrix}$
Step 5:
calculate optimal step size(γ)
      ${γ}^{*} = {min}_{γ} {Ω}_{{EM}_{i}} + γ {y}^{*}$
Step 6:
Calculate next torque split ratio
      Ω_{EM}_{ᵢ₊₁} = Ω_{EM}_{ᵢ} + γ* y*
Step 7:
Ensure first order optimality ∇_{Ω}_{_{EM}} [symbol]  = 0 → [symbol] [symbol]
indicates data missing or illegible when filed
```

### Optimal Traction Control System Evaluation

A route for evaluating the optimal traction control system according to an example implementation was devised. The simulation parameters are shown in TABLE II:

TABLE II
Simulation Parameters

| Parameter | Value | Parameter | Value |
|---|---|---|---|
| Look-ahead horizon (d) [m] | 100 | λ_{g} | [2.79, 1.39] |
| Segments (N) [—] | 10 | cᵣᵣ | 0.005 |
| dx [m] | 10 | Mᵥₑₕ [kg] | 32,500 |
| Route length [km] | 222 | A_{f} [m²] | 8.48 |
| ω₁ [—] | 50 | c_{d} [—] | 0.6 |
| ω₂ [—] | 1 | λ_{d} [—] | 3.91 |

The optimal traction control system, referred to as OTOS (Optimal Torque with Optimal Split), is compared with two other control strategies: CC (Conventional Control), which uses reference speed tracking with even torque split (Ω_{EM}=0.5), and OTES (Optimal Torque with Even Split), which optimizes the total torque but maintains an even split between the e-axles.

Referring to FIG. 5, a graph illustrates an optimal torque profile generated by the optimal traction control system according to an example implementation. The optimal torque profile follows the trend of the road grade, providing more torque on uphill sections and less torque or even negative torque (regenerative braking) on downhill sections.

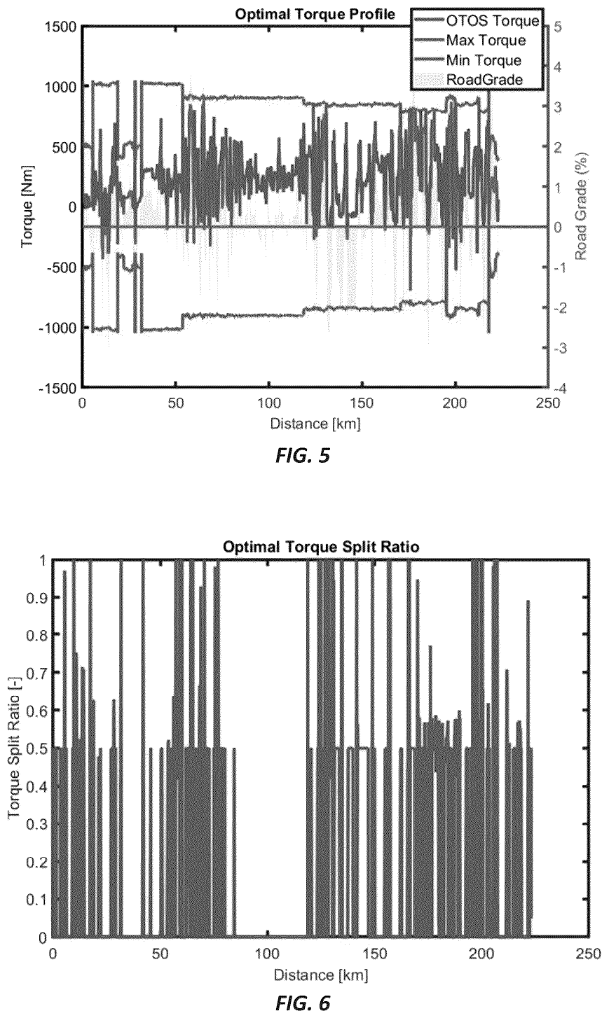

Referring to FIG. 6, a graph illustrates an optimal torque split generated by the optimal traction control system according to an example implementation. The optimal torque split varies significantly based on the operating conditions, with values ranging from 0 (all torque provided by axle 2) to 1 (all torque provided by axle 1) and including intermediate values.

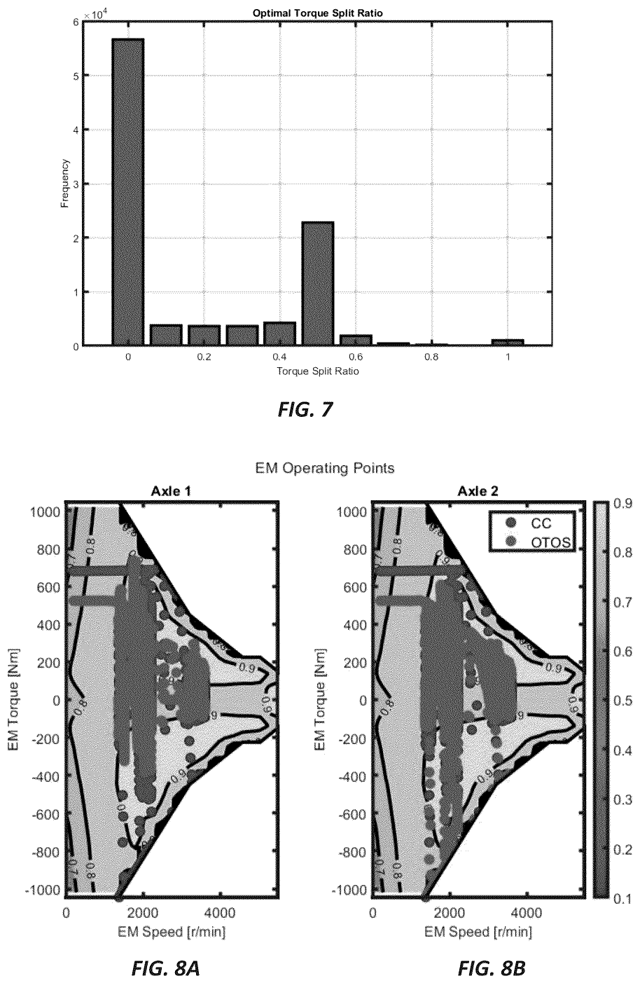

Referring to FIG. 7, a graph illustrates the frequency of each optimal torque split according to an example implementation. The graph shows that zero torque split (only one axle used for traction) is selected most frequently, followed by even split (θ_{EM}=0.5) in more demanding driving conditions. This indicates that in many operating conditions, it is more efficient to use only one e-axle rather than distributing torque evenly between both e-axles.

Referring to FIGS. 8A and 8B, there are illustrated graphs that compare electric machine operating points between OTOS and CC strategies according to an example implementation. The graph shows that at key operating points, OTOS demands less torque compared to CC due to the energy consumption penalty in the cost function. Also, for negative torque (regenerative braking), OTOS dissipates it on one electric machine to avoid drivetrain losses on both e-axles.

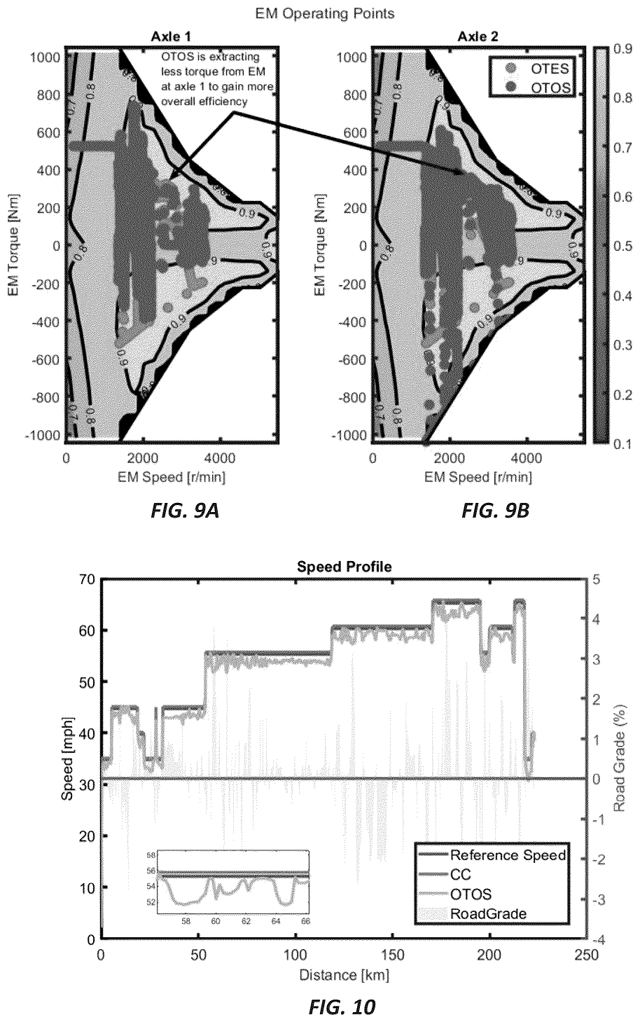

Referring to FIGS. 9A and 9B, there are illustrated graphs that compare electric machine operating points between OTOS and OTES strategies according to an example implementation. The graph shows that in the range from 2000 to 2500 RPM, some OTES operating points are in the 80% efficiency region for both electric machines, while OTOS extracts more torque from one electric machine and zero from the other, shifting operating points into the 90% efficiency region. This uneven split in OTOS reduces electric machine losses by 6.15% compared to OTES.

Referring to FIG. 10, a graph illustrates vehicle speed profiles with different control strategies according to an example implementation. The graph shows that OTOS adapts the vehicle speed to the road grade profile, slowing down on higher grades and speeding up on lower road grades. In contrast, CC tracks the reference speed without adaptation. This adaptive behavior of OTOS results in reduced energy consumption and improved battery state of charge.

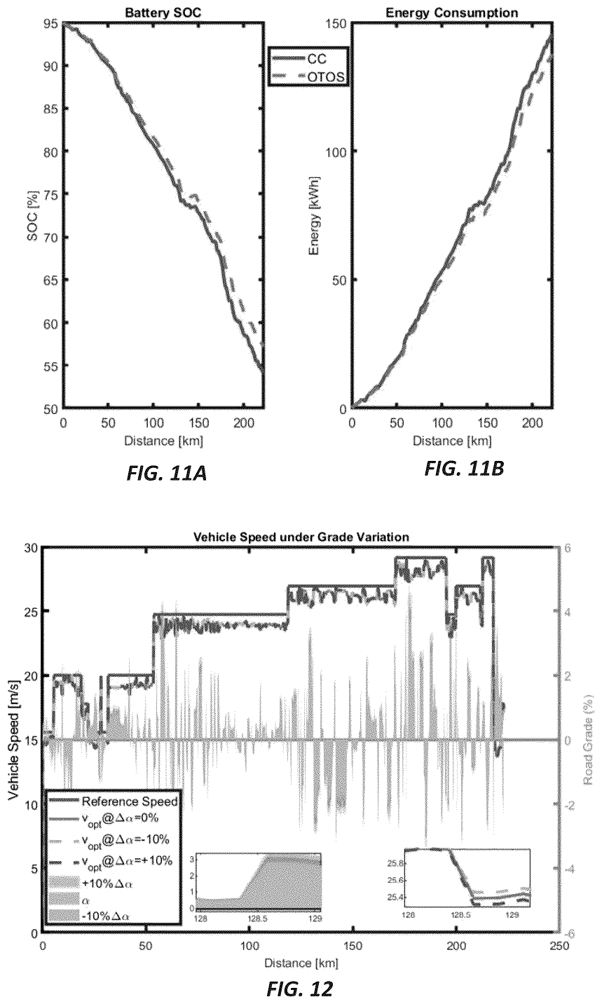

Referring to FIGS. 11A and 11B, there are illustrated graphs that illustrate battery energy profiles with different control strategies according to an example implementation. The graph shows that OTOS consumes less energy compared to CC and OTES, resulting in a higher final state of charge and extended driving range.

The results of the evaluation show that OTOS provides significant improvements compared to CC and OTES.

TABLE III
Results summary

| | | | | Improv.[%] | Improv.[%] | Improv.[%] |
|---|---|---|---|---|---|---|
| Parameter | CC | OTES | OTOS | OTOS vs CC | OTOS vs CC | OTOS vs OTES |
| Energy [kWh] | 145.0507 | 138.1376 | 137.1955 | 5.42 | 4.76 | 0.682 |
| Travel Time [sec] | 9489.3216 | 9848.4431 | 9848.4431 | −3.7 | −3.7 | 0 |
| Final SOC [%] | 54.2618 | 57.0109 | 57.2909 | 5.98 | 5.06 | 0.49 |
| EM Loss [kWh] | 15.7961 | 15.3199 | 14.3763 | 8.99 | 3.01 | 6.15 |
| Drivetrain Loss [kWh] | 9.5844 | 9.3779 | 9.3779 | 2.2 | 2.2 | 0 |
| Range Extension [%] | — | 5.94 | 7.43 | 7.43 | 5.94 | 1.41 |

### Sensitivity Analysis

Referring to FIG. 12, a graph illustrates the impact of road grade variation on vehicle speed according to an example implementation. The graph shows that while road grade variations do affect vehicle speed, the sensitivity remains within an acceptable range, demonstrating the robustness of the optimal traction control system.

TABLE IV
Road grade sensitivity analysis for OTOS

| | | | | | | Improv.[%] |
|---|---|---|---|---|---|---|
| Parameter | Δα = 0 | Δα = −10% | Sensitivity | Δα = +10% | Sensitivity | (CC vs OTOS) |
| Energy [kWh] | 137.19 | 135.92 | 0.092 | 138.42 | 0.089 | 5.42 ± 1 |
| Travel Time [sec] | 9848.44 | 9844.83 | 0.0036 | 9852.16 | 0.0037 | −3.7 ± 0.04 |
| Final SOC [%] | 57.29 | 58.02 | 0.13 | 56.52 | 0.13 | 5.58 ± 1.3 |
| EM Loss [kWh] | 14.37 | 13.81 | 0.39 | 14.98 | 0.42 | 8.99 ± 0.4 |
| Drivetrain Loss [kWh] | 9.37 | 9.34 | 0.032 | 9.41 | 0.04 | 2.2 ± 0.4 |
| Range Extension [%] | 7.43 | 7.80 | 0.03 | 5.21 | 0.24 | 6.5 ± 1.2 |

A sensitivity analysis was conducted to investigate the impact of variations in road grade on the performance of the optimal traction control system. The sensitivity was calculated using the following equation:

$$Senstivity = \frac{\frac{Δ Param .}{Param .}}{\frac{Δα}{α}} \qquad ( 29 )$$

The results of the sensitivity analysis show that energy consumption exhibits a variation of only ±1% when the road grade changes by ±10%, indicating that the vehicle is relatively insensitive to road grade variations in terms of energy consumption. The battery state of charge shows varies ±1.3%, which aligns closely with the variation in energy consumption. Electric machine and drivetrain losses show a sensitivity of ±0.4%. Overall, the sensitivity analysis confirms the robustness of the optimal traction control system.

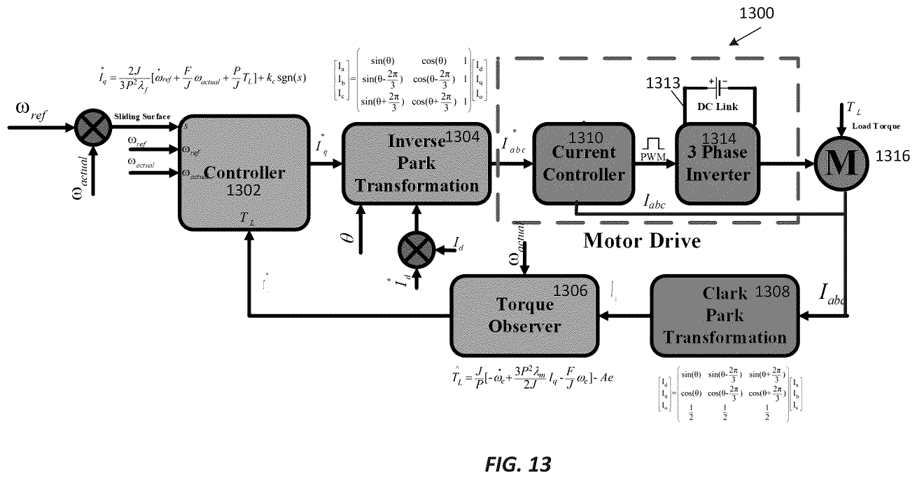

FIG. 13 illustrates another electric machine control system 1300 according to an example implementation. The block diagram shows the components of an EM control system 1300, including a controller 1302, inverse Park transformation 1304, torque observer 1306, Clark Park transformation 1308, current controller 1310, DC link 1312, and 3-phase inverter 1314 to control an EM 1316. The system includes feedback loops for current and position sensing.

In accordance with an aspect, the current controller 1310 may be a hysteresis current controller. A difference between a reference current and a measured current is fed to a relay with a hysteresis band set between +h and −h. When the error exceeds the upper limit, a LOW signal (0) is produced, and when it falls below the lower limit, a HIGH signal (1) is generated.

The load torque observer 1306 provides a real-time estimation of the load torque, enhancing control accuracy, and optimizing the performance and efficiency of the system by adapting to dynamic load variations.

A dynamics-based torque observer is shown in Eq. (30):

$${\hat{τ}}_{L} = \frac{3}{2} p {λ}_{m} {i}_{q} - F {ω}_{actual} - J \frac{d {ω}_{actual}}{dt} \qquad ( 30 )$$

Sliding Mode Torque Observer The sliding mode observer is shown in Eq. (31):

$${\hat{τ}}_{L} = \frac{α}{β + ( 1 + \vert \frac{1}{x} \vert - β ) {e}^{γ \vert s \vert}} sgn ( s ) + A [ J \int ( \frac{3}{2 J} p {λ}_{m} {i}_{q} ) - ( \frac{F - J}{J} ) {ω}_{actual} ] \qquad ( 31 )$$

A Physics-Informed Neural Network (PINN)-based torque observer offers advantages over the Sliding Mode Observer (SMO). PINNs integrate physical laws into their structure, enabling accurate modeling of the non-linear dynamics inherent in electric truck operations while maintaining robustness against noise and uncertainties. Unlike SMOs, which require fine-tuning and are prone to chattering, PINNs adapt dynamically to changing operating conditions, such as varying road profiles, payloads, and thermal stresses. The mathematical representation of the PINN torque observer is Eq. (32):

$$\hat{{T}_{L}} = {W}_{out} ( {h}_{hidden} ( {W}_{hidden} ( {h}_{i n} ( {{W}_{i n} [ \begin{matrix}ω & {i}_{q} & T\end{matrix} ]}^{t} ) + {b}_{i} n ) + {b}_{hidden} ) ) ) + {b}_{out} \qquad ( 32 )$$

The bias matrices bᵢₙ=b_{hidden}=bₒᵤₜ=0 so the Eq. (31) can be written as Eq. (33)

$${T}_{L} = W σ ( {V [ \begin{matrix}ω & {i}_{q} & T\end{matrix} ]}^{t} ) \qquad ( 33 )$$

where W and V are the weight matrices of output and hidden layers. σ is relu activation function.

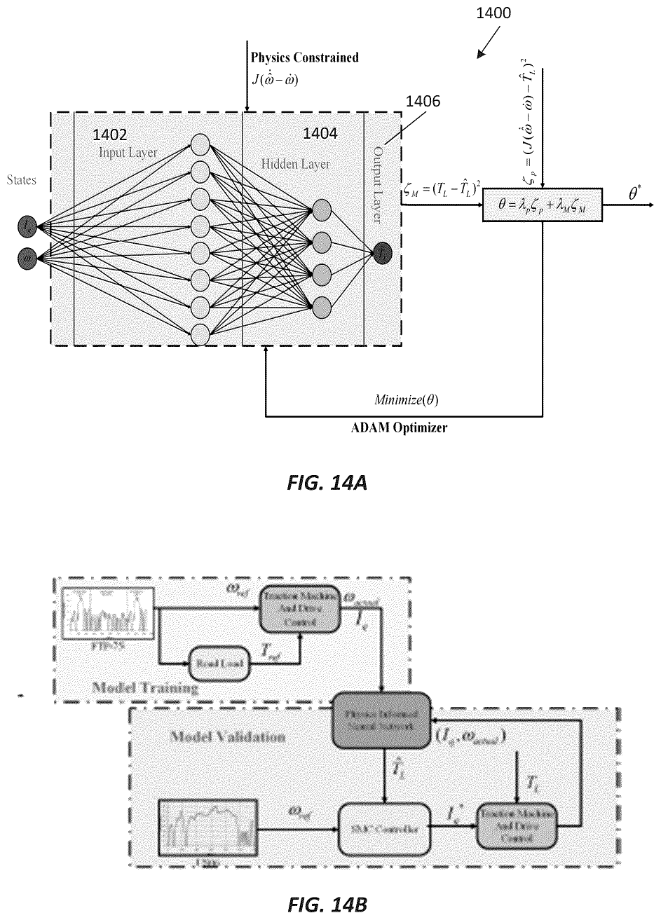

FIGS. 14A-14B illustrate a neural network architecture 1400 for torque estimation according to an example implementation (FIG. 14A) and a training and validation scheme (FIG. 14B). A simplified neural network is illustrated with an input layer 1402, hidden layers 1404, and output layer 1406. This architecture 1400 is used for machine learning-based torque observation, which requires less computational resources on hardware compared to traditional observers.

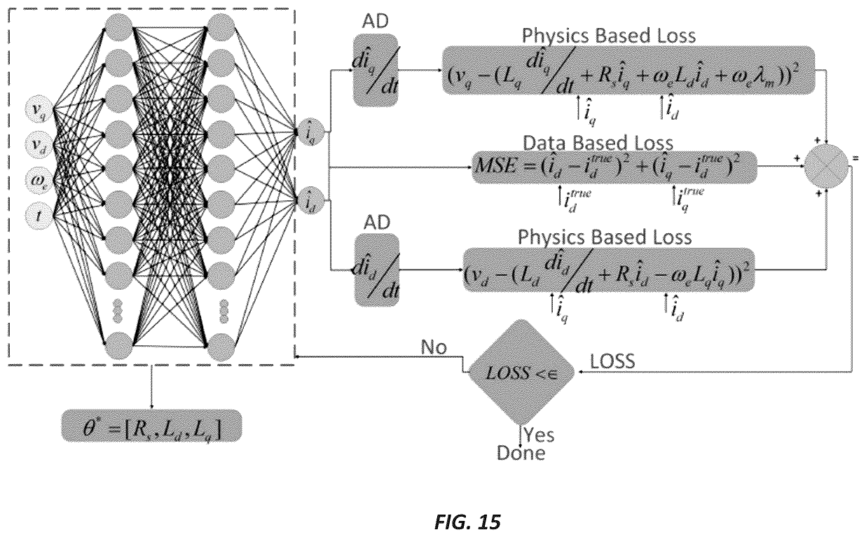

In accordance with aspects of the present disclosure, parameter estimation of Permanent Magnet Synchronous Machines (PMSMs) using Physics-Informed Neural Networks (PINNs) will now be described. The systems and methods may integrate machine governing differential equations directly into neural network training loss functions, combining physics-based residuals with mean squared error on measured data to enable accurate estimation of critical motor parameters. FIG. 15 is an example block diagram of PINN based PMSM Parameter Estimator that may be implemented in accordance with the following details.

PMSMs may be broadly categorized into two types: Surface Mount Permanent Magnet Synchronous Machines (SPMSMs), where the direct-axis inductance equals the quadrature-axis inductance (L_{d}=L_{q}), and Interior Permanent Magnet Synchronous Machines (IPMSMs), where the direct-axis inductance is less than the quadrature-axis inductance (L_{d}<L_{q}). The parameter estimation approach described herein may address both types of machines with appropriate adjustments to the physics-based loss function.

The parameter estimation challenge in PMSMs may stem from rank deficiency issues, where multiple unknown parameters must be estimated from a limited number of independent equations. Traditional parameter estimation methods may struggle with this challenge, particularly in dynamic operating conditions typical of electric vehicle (EV) applications. The PINN-based approach may overcome these limitations by leveraging both physical knowledge and measured data.

The dynamic equations of PMSM in the rotating d-q frame may be expressed as follows:

$$\frac{{di}_{d}}{dt} = - \frac{{R}_{s}}{{L}_{d}} {i}_{d} + \frac{{ω}_{e} {L}_{q}}{{L}_{d}} {i}_{q} + \frac{{υ}_{d}}{{L}_{d}}$$

$$\frac{{di}_{q}}{dt} = - \frac{{ω}_{e} {L}_{d}}{{L}_{q}} {i}_{d} - \frac{{R}_{s}}{{L}_{q}} {i}_{q} + \frac{{υ}_{q}}{{L}_{q}} - \frac{{ω}_{e} {λ}_{m}}{{L}_{q}}$$

$${T}_{e} = \frac{3}{2} p ( {λ}_{m} {i}_{q} + ( {L}_{d} - {L}_{q} ) {i}_{d} {i}_{q} )$$

$$J = \frac{d ω}{dt} = {T}_{e} - {T}_{L} - F ω$$

where I_{d} may represent direct-axis current, I_{q} may represent quadrature-axis current, Rs may represent stator resistance, ω may represent angular electrical velocity, Tₑ may represent machine torque, p may represent number of poles, J may represent rotor inertia, TL may represent load torque, T_{f} may represent viscous friction torque, Ud may represent direct-axis voltage, U_{q} may represent quadrature-axis voltage, L_{d} may represent direct-axis inductance, L_{q} may represent quadrature-axis inductance, and ψₐ may represent permanent magnet flux linkage.

Parameter observability theory may be applied to analyze the observability of state variables in the PMSM system. For a dynamic system described by:

$$\frac{d}{dt} x = f ( x , u ) , y = h ( x )$$

where x∈ [symbol] may be a vector of state variables, u∈ [symbol] may be an input vector, y may be an output vector, and f and h may be state and output functions, respectively. The vector of state variables x above may be considered observable if the observability matrix O has full rank:

$$rank ( O ) = n$$

where O may be the Jacobian matrix of Lie derivatives:

$$O = \frac{\partial L}{\partial x} , L = [ {ℒ}_{f}^{0} h , {ℒ}_{f}^{1} h , … , {ℒ}_{f}^{n - 1} h ]$$

In this expression,

$${ℒ}_{f}^{k}$$

h may refer to the k^{th} order Lie derivative of the output function h.

When applying parameter observability theory to PMSM, the state variables may be extended to include motor parameters. Assuming that all motor parameters remain constant within a short time period:

$$\frac{{di}_{d}}{dt} = - \frac{{R}_{s}}{{L}_{d}} {i}_{d} + \frac{{ω}_{e} {L}_{q}}{{L}_{d}} {i}_{q} + \frac{{υ}_{d}}{{L}_{d}}$$

$$\frac{{di}_{q}}{dt} = - \frac{ω {L}_{d}}{{L}_{q}} {i}_{d} - \frac{{R}_{s}}{{L}_{q}} {i}_{q} + \frac{1}{{L}_{q}} ( {υ}_{q} - {ω}_{e} {λ}_{m} )$$

$$\frac{{dR}_{s}}{dt} = 0 , \frac{d {L}_{d}}{dt} = 0 , \frac{d {L}_{q}}{dt} = 0 , \frac{d {λ}_{m}}{dt} = 0$$

The state vector x(t), input vector u(t), state function f(x,u), system matrix A(t), and output vector y(t) may be defined as:

$$x = {[ {i}_{d} {i}_{q} {R}_{s} {L}_{q} {L}_{q} {λ}_{m} ]}^{T} , y = h ( x ) = {[ {i}_{d} , {i}_{q} ]}^{T}$$

$$u = {[ {υ}_{d} {υ}_{q} {ω}_{e} ]}^{T}$$

$$A = [ \begin{matrix}- \frac{{R}_{s}}{{L}_{d}} & {ω}_{e} \frac{{L}_{q}}{{L}_{d}} \\ - {ω}_{e} \frac{{L}_{d}}{{L}_{q}} & - \frac{{R}_{s}}{{L}_{q}}\end{matrix} ]$$

$$f ( x , u ) = [ \begin{matrix}- \frac{{R}_{s}}{{L}_{d}} {i}_{d} + \frac{{ω}_{e} {L}_{q}}{{L}_{d}} {i}_{q} + \frac{{υ}_{d}}{{L}_{d}} \\ - \frac{ω {L}_{d}}{{L}_{q}} {i}_{d} - \frac{{R}_{s}}{{L}_{q}} {i}_{q} + \frac{1}{{L}_{q}} ( {υ}_{q} - {ω}_{e} {λ}_{m} \\ 0 \\ 0 \\ 0 \\ 0\end{matrix} ]$$

The Lie derivative of output function h can be described as:

$${ℒ}_{f}^{0} h = h = {[ {i}_{d} {i}_{q} ]}^{T}$$

$${ℒ}_{f}^{1} h = ( ∇ h ) f = {[ \frac{d}{dt} {i}_{d} \frac{d}{dt} {i}_{q} ]}^{T}$$

$${ℒ}_{f}^{2} h = ( ∇ {ℒ}_{f}^{1} h ) f = {A [ \frac{d}{dt} {i}_{d} \frac{d}{dt} {i}_{q} ]}^{T}$$

$${ℒ}_{f}^{3} h = ( ∇ {ℒ}_{f}^{2} h ) f = {{A}^{2} [ \frac{d}{dt} {i}_{d} \frac{d}{dt} {i}_{q} ]}^{T}$$

$${ℒ}_{f}^{4} h = ( ∇ {ℒ}_{f}^{3} h ) f = {{A}^{3} [ \frac{d}{dt} {i}_{d} \frac{d}{dt} {i}_{q} ]}^{T}$$

$${ℒ}_{f}^{5} h = ( ∇ {ℒ}_{f}^{4} h ) f = {{A}^{4} [ \frac{d}{dt} {i}_{d} \frac{d}{dt} {i}_{q} ]}^{T}$$

The resulting observability matrix may be as follows:

$$O = [ \begin{matrix}- {i}_{d} & 0 & {i}_{d} & 0 \\ - {i}_{q} & - {i}_{d} {ω}_{e} & 0 & - {ω}_{e} \\ {R}_{s} {i}_{q} - {ω}_{e} {L}_{d} {i}_{q} & - {ω}_{e}^{2} {l}_{d} {i}_{d} & - {R}_{s} {ω}_{e} {i}_{q} & - {ω}_{e}^{2} {L}_{d} \\ {R}_{s} {i}_{q} + {ω}_{e} {L}_{d} {i}_{q} & {R}_{s} {ω}_{e} {i}_{d} & - {ω}_{e}^{2} {L}_{q} {i}_{q} & {R}_{s} {ω}_{e}\end{matrix} ]$$

Analysis of the Lie derivatives and the resulting observability matrix may reveal that PMSM parameters are not fully observable due to their strong correlation, which may prevent the PMSM equations from providing independent solutions. This non-observability challenge may be addressed by introducing learning-based approaches, such as Physics-Informed Neural Networks (PINNs).

The PINN approach may embed the governing physical equations of the PMSM into the learning framework, leveraging both measurement data and fundamental machine dynamics to enforce physical consistency and improve parameter observability. Unlike conventional methods that may rely solely on numerical optimization, the learning-based approach may discover hidden patterns and implicitly regularize the estimation problem by incorporating domain knowledge.

To estimate PMSM parameter values, a neural network, such as shown in FIGS. 14A, 14B and 15 may be designed to map inputs to predicted parameters. The neural network may be trained using a loss function that consists of two components: a physics-based loss that may constrain the output to satisfy the PMSM dynamic equations, and a data loss that may penalize deviations from measured values.

The physics-based loss (Lₚ,p_{b}) may be formulated as:

$${ℒ}_{physics} = {\sum }_{t} {‖ \frac{d}{dt} [ \begin{matrix}{\hat{i}}_{d} \\ {\hat{i}}_{q}\end{matrix} ] - ( A ( θ ) [ \begin{matrix}{\hat{i}}_{d} \\ {\hat{i}}_{q}\end{matrix} ] + B ( θ ) u + h ( x ) ) ‖}^{2}$$

The data-based loss ( [symbol] _{data}) may be defined as:

$${ℒ}_{data} = {\sum }_{t} ( {‖ {i}_{d}^{true} - {\hat{i}}_{d} ‖}^{2} + {‖ {i}_{q}^{true} - {\hat{i}}_{q} ‖}^{2} )$$

where

$${i}_{d}^{meas} and {i}_{q}^{meas}$$

represents the measured current values. while \hat{ι}_{q} and \hat{ι}_{d} are predicted current values.

The total loss ( [symbol] ₜₒₜₐₗ) may be defined as:

$${ℒ}_{total} = {αℒ}_{data} + {βℒ}_{physics}$$

where β may be a weighting factor that balances the contribution of the physics-based and data-based loss components.

The neural network parameters may be optimized by minimizing the total loss:

$${θ}^{*} = {arg min}_{θ} {ℒ}_{total}$$

where θ* may represent the optimized PMSM parameters. The optimization process may be performed using algorithms such as Adam or L-BFGS, leveraging backpropagation to update the neural network weights.

The PINN-based parameter estimation approach may be implemented according to the following algorithm 3:

Algorithm 3 PINN-Based PMSM Parameter Estimation

| | |
|---|---|
| 1: | Input: Training data $\{ {υ}_{d} , {v}_{q} , ω , t ; {i}_{d}^{true} , {i}_{q}^{true} \}$ |
| 2: | Initialize: Neural network parameters θ for estimating |
| | i_{d}, i_{q}, and PMSM parameters Rₛ, L_{d}, L_{q}, λₘ |
| 3: | for each training epoch do |
| 4: | Compute predicted currents: ${i}_{d}^{pred} , {i}_{q}^{pred} = NN ( {υ}_{d} , {v}_{q} , ω , t ; θ )$ |
| 5: | Compute gradients $\frac{{di}_{d}^{pred}}{dt} and \frac{{di}_{q}^{pred}}{dt}$ |
| | using automatic differentiation |
| 6: | Calculate Physics-based Loss: |
| | ${L}_{physics} = {( {v}_{d} - ( {R}_{s} {i}_{d}^{pred} + {L}_{d} \frac{{di}_{d}^{pred}}{dt} - ω {L}_{q} {i}_{q}^{pred} ) )}^{2} +$ |
| | ${( {v}_{q} - ( {R}_{s} {i}_{q}^{pred} + {L}_{q} \frac{{di}_{q}^{pred}}{dt} + ω {L}_{d} {i}_{d}^{pred} + {ωλ}_{m} ) )}^{2}$ |
| 7: | Calculate Data-driven Loss: |
| | ${L}_{mse} = MSE ( {i}_{d}^{pred} , {i}_{d}^{true} ) + MSE ( {i}_{q}^{pred} , {i}_{q}^{true} )$ |
| 8: | Combine losses: Lₜₒₜₐₗ = L_{physics} + Lₘₛₑ |
| 9: | Update θ, Rₛ, L_{d}, L_{q}, λₘ using backpropagation and |
| | optimizer (Adam) |
| 10: | Save loss values and parameter estimates for each epoch |
| 11: | end for |
| 12: | Output: Trained neural network, estimated parameters, |
| | and prediction functions = 0 |

The PINN-based parameter estimation approach may be evaluated for both SPMSM and IPMSM cases. For the SPMSM case, where L_{d}=L_{q}, the PINN may be trained on data recorded from simulation. The loss curves may show that initially, all losses may be high, indicating large prediction errors, but they may quickly decrease as the model learns. By the end of training, losses may reach very stable values, demonstrating that the model effectively balances physical constraints and data fitting.

For the IPMSM case, where L_{d}<L_{q}, the loss curves may show a more gradual convergence compared to the SPMSM case. The total loss, composed of the physics-based loss and mean squared error (MSE) loss, may start high and rapidly decrease within the first 50 epochs, eventually stabilizing at a low value. The convergence behavior may indicate that the model quickly learns the underlying dynamics and balances data-driven and physics-based learning.

The parameter estimation results may show that for both SPMSM and IPMSM cases, the PINN approach may successfully estimate the stator resistance (Rs) and the direct- and quadrature-axis inductances (L_{d} and L_{q}) with high accuracy. For the SPMSM, the parameter estimation may converge smoothly and quickly, with the loss function showing a steady reduction with earlier iterations. The simpler machine dynamics, with L_{d}=L_{q}, may contribute to the quicker estimation.

In contrast, the IPMSM may present more complexity due to its parameter coupling, which may lead to slower convergence initially. Despite this, the PINN approach may be able to accurately estimate the parameters, underscoring its adaptability to more complex machine types.

The PINN framework may prove effective for both SPMSM and IPMSM cases, where in the latter case, three unknown parameters must be estimated from two equations. In both cases, PINN may successfully estimate the stator resistance (Rs) and the direct- and quadrature-axis inductances (L_{da} and L_{q}) with high accuracy, highlighting its potential in effectively modeling and estimating key parameters in different electric machine types.

The PINN-based parameter estimation approach may offer several advantages over traditional methods. First, it may address the rank deficiency issue by leveraging both physics-based constraints and data-driven learning. Second, it may provide accurate parameter estimates even in dynamic operating conditions typical of EV applications. Third, it may be adaptable to different types of PMSMs with appropriate adjustments to the physics-based loss function.

The PINN-based parameter estimation approach may be implemented in various applications, including electric vehicle (EV) powertrain systems, where accurate motor parameter estimation may be critical for optimal control strategies such as Field-Oriented Control (FOC), Direct Torque Control (DTC), and Maximum Torque Per Ampere (MTPA). It may also be applied in dynamic load conditions, real-time control systems, and other applications utilizing PMSMs.

The PINN architecture for PMSM parameter estimation may consist of several components. The neural network core may include an input layer that receives time-series data of voltage, current, and speed measurements, hidden layers with appropriate activation functions, and an output layer that predicts the PMSM parameters (Rₛ, L_{d}, L_{q}).

The automatic differentiation module may compute derivatives of estimated states with respect to time, enabling calculation of physics-based residuals from differential equations. The loss function components may include a physics-based loss that enforces adherence to PMSM governing equations, a data-driven loss that measures discrepancy between predicted and measured values, and a combined loss that represents a weighted sum of physics-based and data-driven losses.

The parameter estimation pipeline may include data preprocessing for filtering and normalization of input signals, a training loop for iterative optimization of neural network weights, and parameter extraction for obtaining final parameter estimates. The integration interface may accept voltage, current, and speed measurements as inputs and provide estimated parameters to motor control algorithms as outputs.

The PINN-based parameter estimation approach may be implemented using various hardware components. The sensing hardware may include current sensors for measuring phase currents, voltage sensors for measuring phase voltages, and position/speed sensors for measuring rotor position and speed. The data acquisition system may include analog-to-digital converters (ADCs), signal conditioning circuits, and sampling and timing control.

The computational hardware may include a microcontroller or digital signal processor (DSP), memory for storing neural network parameters, and floating-point computation units for neural network operations. The motor drive system may include power electronics (inverter), gate drivers, and the PMSM motor (either SPMSM or IPMSM). The control interface may include communication protocols and a user interface for parameter visualization and system configuration.

The PINN-based parameter estimation approach may be integrated into existing electric drive systems, utilizing their sensing and actuation capabilities while adding the PINN-based parameter estimation functionality. This integration may enhance the performance and efficiency of electric drive systems, particularly in EV applications where accurate parameter estimation may be critical for optimal control.

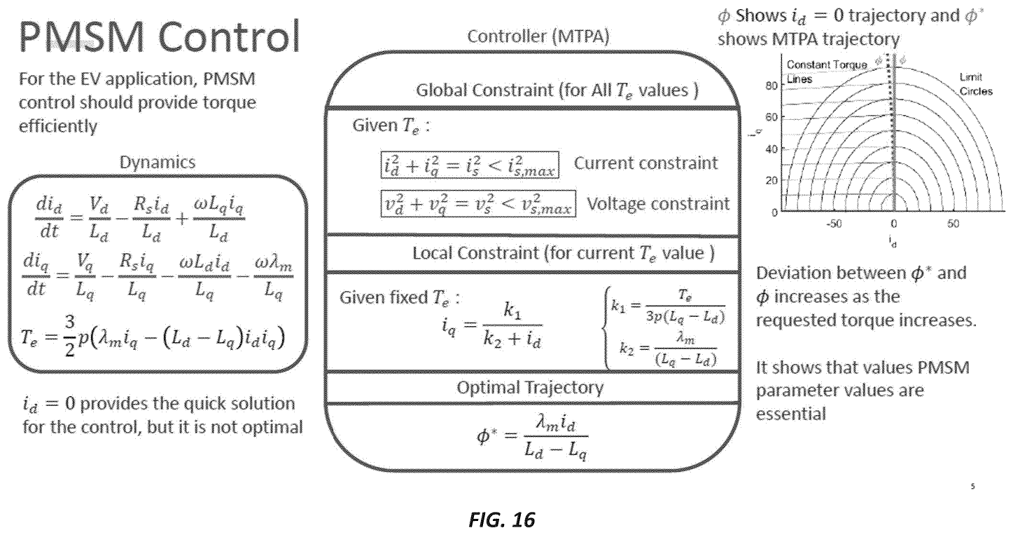

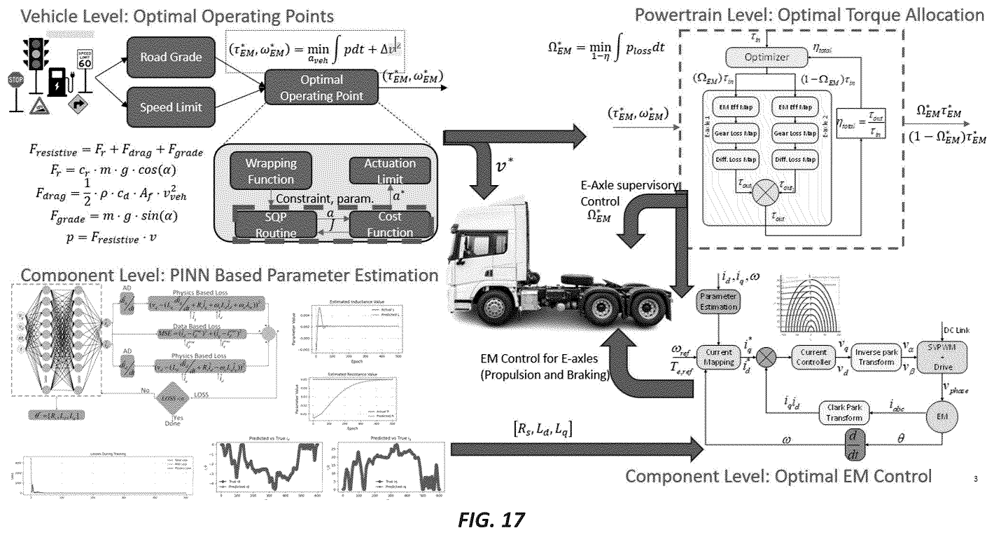

FIG. 16 illustrates an overview of a electric machine control method in accordance with the above. It generates the optimal current reference, which tracks the requested operating point (speed and torque) with minimized current. FIG. 17 is an overview showing the relationships between the aspects described herein to provide an Energy Optimal Traction Control system. Each aspect provides energy efficiency. At vehicle level, it generates the optimal torque profile/operating points which adapts to road grade variations. At powertrain level, optimal torque is divided between multi e-axles optimally to minimize whole powertrain losses. Lastly, at component level, optimal torque profile is tracked by electric machines with minimized current. Since electric machine parameters varies with temperature. So, PINN based parameter is designed to estimate the parameters for electric machines controller.

### CONCLUSION

The optimal traction control system for multi e-axle based electrified vehicles provides significant improvements in energy efficiency and driving range compared to conventional control strategies. By optimizing both the torque profile based on look-ahead information and the torque distribution between e-axles, the system can reduce energy consumption, minimize powertrain losses, and extend driving range.

The evaluation results demonstrate that the optimal traction control system can reduce energy consumption, extend driving range, and reduce electric machine losses and drivetrain losses compared to conventional control strategies. These improvements address the challenge of range anxiety in electric vehicles, particularly heavy-duty electric trucks, making them more viable for long-distance transportation.

The sensitivity analysis confirms the robustness of the optimal traction control system, as key performance metrics remain within acceptable limits despite significant variations in road grade. This robustness ensures reliable performance under varying operating conditions, further enhancing the viability of electric vehicles for diverse applications.

Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure.

The order or sequence of any process or method steps may be varied or resequenced according to alternative implementations. Other substitutions, modifications, changes, and omissions may be made in the design, operating conditions, and arrangement of the implementations without departing from the scope of the present disclosure. The present disclosure contemplates methods, systems, and programming products on any machine-readable media for accomplishing various operations.

The implementations of the present disclosure may be implemented using existing computer processors, or by a special purpose computer processor for an appropriate system, incorporated for this or another purpose, or by a hardwired system. Implementations within the scope of the present disclosure include programming products including machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, solid-state memory or disk, optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired and wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a”, “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps.

“Exemplary” means “an example of” and is not intended to convey an indication of a preferred or ideal implementation. “Such as” is not used in a restrictive sense, but for explanatory purposes. Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed:

1. A method for optimizing traction control in an electric vehicle with multiple e-axles, comprising:
receiving look-ahead information about upcoming road conditions;
generating an optimal torque profile based on the look-ahead information; and
optimally allocating the requested torque between multiple e-axles to minimize energy losses.

2. The method of claim 1, wherein the look-ahead information comprises road grade and speed limits.

3. The method of claim 1, wherein generating the optimal torque profile comprises:
calculating vehicle load forces based on the look-ahead information;
formulating a cost function that considers energy consumption and speed tracking; and
solving an optimization problem to determine the optimal torque profile.

4. The method of claim 3, wherein solving the optimization problem comprises using a nonlinear optimization technique.

5. The method of claim 1, wherein optimally allocating the requested torque comprises:
calculating power losses for each e-axle at different torque split ratios;
formulating an objective function to minimize total power losses; and
determining an optimal torque split ratio that minimizes the objective function.

6. The method of claim 5, wherein calculating power losses comprises considering losses in electric machines, gearboxes, and differential gears.

7. The method of claim 1, further comprising:
adapting vehicle speed based on road grade, wherein the vehicle slows down on higher grades and speeds up on lower grades.

8. A system for optimizing traction control in an electric vehicle with multiple e-axles, comprising:
a vehicle control unit configured to receive look-ahead information and generate an optimal torque profile;
an e-axles supervisory controller configured to optimally allocate torque between multiple e-axles; and
electric machine controllers configured to implement the allocated torque commands.

9. The system of claim 8, wherein the vehicle control unit is configured to:
calculate vehicle load forces based on the look-ahead information;
formulate a cost function that considers energy consumption and speed tracking; and
solve an optimization problem to determine the optimal torque profile.

10. The system of claim 8, wherein the e-axles supervisory controller is configured to:
calculate power losses for each e-axle at different torque split ratios;
formulate an objective function to minimize total power losses; and
determine an optimal torque split ratio that minimizes the objective function.

11. The system of claim 8, wherein the electric vehicle comprises a heavy-duty electric truck with dual e-axles.

12. The system of claim 8, wherein each e-axle comprises an electric machine, a gearbox, and a differential gear.

13. The system of claim 8, wherein the vehicle control unit is further configured to adapt vehicle speed based on road grade.

14. A method for extending the range of an electric vehicle, comprising:
optimizing a torque profile based on look-ahead information about road grade and speed limits;
determining an optimal torque split between multiple e-axles to minimize energy losses; and
controlling the electric machines according to the optimal torque split.

15. The method of claim 14, wherein optimizing the torque profile comprises:
dividing a look-ahead distance into multiple segments;
calculating road load for each segment based on road grade, vehicle speed, and other parameters;
formulating a cost function considering energy consumption and speed tracking; and
solving the optimization problem to determine the optimal torque profile.

16. The method of claim 14, wherein determining the optimal torque split comprises:
calculating efficiency of each e-axle at different operating points;
formulating a cost function to minimize total powertrain losses; and
solving the optimization problem to determine the optimal torque split.

17. The method of claim 14, wherein controlling the electric machines comprises:
operating one electric machine at a higher torque and the other at a lower torque or zero torque based on the optimal torque split.

18. The method of claim 14, wherein the optimal torque split varies dynamically based on operating conditions, with zero torque split selected most frequently.

19. The method of claim 14, wherein the method reduces energy consumption by at least 5% compared to conventional control strategies with even torque split.

20. The method of claim 14, wherein the method extends driving range by at least 7% compared to conventional control strategies with even torque split.
